(19) United States
(12) Patent Application Publication
(10) Pub. No.: US 2014/0058827 A1
(43) Pub. Date: Feb. 27, 2014

(54) METHOD AND APPARATUS FOR OPTIMIZING THE DELIVERY OF DISPLAY ADVERTISING IMPRESSIONS

(71) Applicants: Andrey SVIRSKY, Sunnyvale, CA (US); Goutham KURRA, San Francisco, CA (US)

(72) Inventors: Andrey SVIRSKY, Sunnyvale, CA (US); Goutham KURRA, San Francisco, CA (US)

(21) Appl. No.: 13/595,818

(22) Filed: Aug. 27, 2012

(51) Int. Cl. G06Q 30/02

(52) U.S. Cl. 705/14.43

(57) ABSTRACT

In a display advertising environment, within the constraint of a fixed advertising budget, and fixed or variable price per impression, delivery of the above mentioned budget is maintained as a priority by application of a pacing filter, while the click rate per impression (CTR), or action rate per impression (AR), is maximized by application of a CTR/AR filter.

### BACKGROUND OF THE INVENTION

1. Technical Field

The invention relates to display advertising. More particularly, the invention relates to optimizing the delivery of display advertising impressions.

2. Description of the Background Art

Display advertising appears on the Internet as a form of online advertising and appears on Web pages in many forms, including Web banners. The placing of display advertising is often a function of a fixed budget campaign, where the budget is comprised of all the funds paid for a number of impressions that are to be delivered. Impressions are delivered in ad slots and not all ad slots are created equal. Some ad slots have a higher probability of generating a click than others, that is they have a higher impression value. In some cases, certain advertisers may want an advertising campaign that is not necessarily optimized for impression value, e.g. they pay price for each ad impression regardless of its value. At the same time, the advertisers also want more clicks. Thus, they may want to have a fixed budget to be delivered as a priority, but they may also want to maximize the click rate. In such case, there are two competing goals, i.e. delivering the budget is the primary goal, but maximizing the number of clicks for the budget is also key. Unfortunately, accomplishing this is not simple.

The problem can also be extended to any kind of predictable event, such as a user clicking an ad, completing a checkout process, requesting a quote, signing up for form, etc.

One approach to addressing this problem is to look at possible optimization techniques. Here, an analogy is helpful. Consider mushroom hunting with a backpack. Each time a mushroom is found a decision is made whether or not to pick it up. This is a quick mental decision based on whether enough mushrooms have already been collected given the amount of time available to collect mushrooms. This is another way of stating the classic knapsack problem.

The knapsack problem or rucksack problem is a problem in combinatorial optimization: Given a set of items, each with a weight and a value, determine the number of each item to include in a collection so that the total weight is less than or equal to a given limit and the total value is as large as possible. It derives its name from the problem faced by someone who is constrained by a fixed-size knapsack and must fill it with the most valuable items. The problem often arises in resource allocation where there are financial constraints and is studied in fields such as combinatorics, computer science, complexity theory, cryptography, and applied mathematics.

The mushroom hunting analogy is apposite. There is only limited time for going through the forest trying to fill a knapsack with mushrooms, e.g. two hours. You start by picking up pretty much any mushroom that comes your way. But once half of the knapsack is already filled with mushrooms, then the threshold with regard to how good a mushroom has to be to pick it up is high because there is no doubt about being able to fill the knapsack in the portion of the time budget that remains. Thus, as the knapsack is filled, the process of picking mushrooms becomes more and more selective.

### SUMMARY OF THE INVENTION

The inventors have recognized that it is possible to frame the problem of staying within an advertising budget while maximizing clicks as that of filling an online knapsack. There is a fixed volume, i.e. an advertising budget to spend on impressions, but each individual click has its own value. That is, some impressions are more valuable than others. To solve this problem, it is necessary to pick only items (impressions) with the highest value possible (highest likelihood of a click), but it is not known in advance how these impressions are distributed. At first, then, all impressions may be purchased, but eventually as the budget is expended the selection process becomes more selective, so that only the most valuable impressions, i.e. those more likely to result in a click, are chosen.

### BRIEF DESCRIPTION OF THE DRAWINGS

FIG. 1 is a dataflow diagram showing a mechanism for optimizing the delivery of display advertising impressions according to the invention;

FIG. 2 shows four iterations of a sampling and filtering procedure according to the invention; and

FIG. 3 is a block schematic diagram of a machine in the exemplary form of a computer system within which a set of instructions for causing the machine to perform any one of the herein disclosed methodologies may be executed.

### DETAILED DESCRIPTION OF THE INVENTION

Embodiments of the invention address the problem of providing a fixed advertising budget that includes delivery of a number of impressions as a priority, while also maximizing advertiser performance, e.g. measured as clicks per impressions rate (CTR) or actions per impression rate (AR), depending on campaign configuration. For purposes of the discussion herein an action is any kind recordable event that user performs after being exposed to an ad, for example completing a purchase in an online store, signing up for an event, etc. Embodiments of the invention provide a mechanism for optimizing delivery of impressions for a fixed advertising budget, typically as a primary goal, while also maximizing the number of clicks/actions for the budget. In such case, even though the delivery of a certain number of impressions is guaranteed, there is no way to know for certain in advance how this delivery can occur because of the volatile nature of the on-line advertising market. Depending on such factors on the target competitive environment, availability of publishers, and the like, it is not certain whether there can be delivery of enough impressions that an advertiser has required an agency to deliver. In such case, delivery of the required number of impressions is the number one priority, i.e. it is absolutely necessary to deliver each and every impression.

For each ad impression, the probability of a click or action is estimated separately. Thus, for each impression there is an estimate of how likely an ad impression is to result in a click or action. In an embodiment, threshold filters are set up for every ad to decide whether to accept the impression or not based upon the predicted click-through rate (CTR) or action rate (AR) for the impression. For example, some small budget advertiser may have $100 per day to spend and wants 100,000 impressions. In the real world, an agency might have 1,000,000 daily impressions available that match the advertiser bid and targeting. The advertiser may be qualified for any 100,000 of 1,000,000 impressions. Accordingly, the advertiser may have the luxury of cherry-picking, i.e. only accepting those impressions where the predicted click rate is higher. One aspect of the invention provides a controlled feedback mechanism that re-estimates the budgeted number of impressions over fixed time periods to determine if the rate of impressions is on target, if the budget is going to be filled, if there are too many impressions, and the like. If there are too many impressions, the filter threshold is raised. If only a very few impressions are placed, the filter threshold is lowered.

There is a ratio between impressions and clicks. Clicks are desirable results of an impression. As discussed above, the first goal for purposes of the invention is to deliver impressions, and the second goal is to maximize the number of clicks. The filtering and threshold adjustments effect a form of a throttling based upon sampling. Sampling allows an advertiser to spread their budget. If there are a certain number of impressions available, but it is only necessary to deliver a portion of those that are available, then only some of the impressions are delivered. The sampling ratio and the throttling that is based on a prediction are closely related. Thus, random sampling is used to make sure that the budget is spread throughout an advertising cycle, while filtering operates in addition to sampling, and is based on an estimate or click-through rate for each impression.

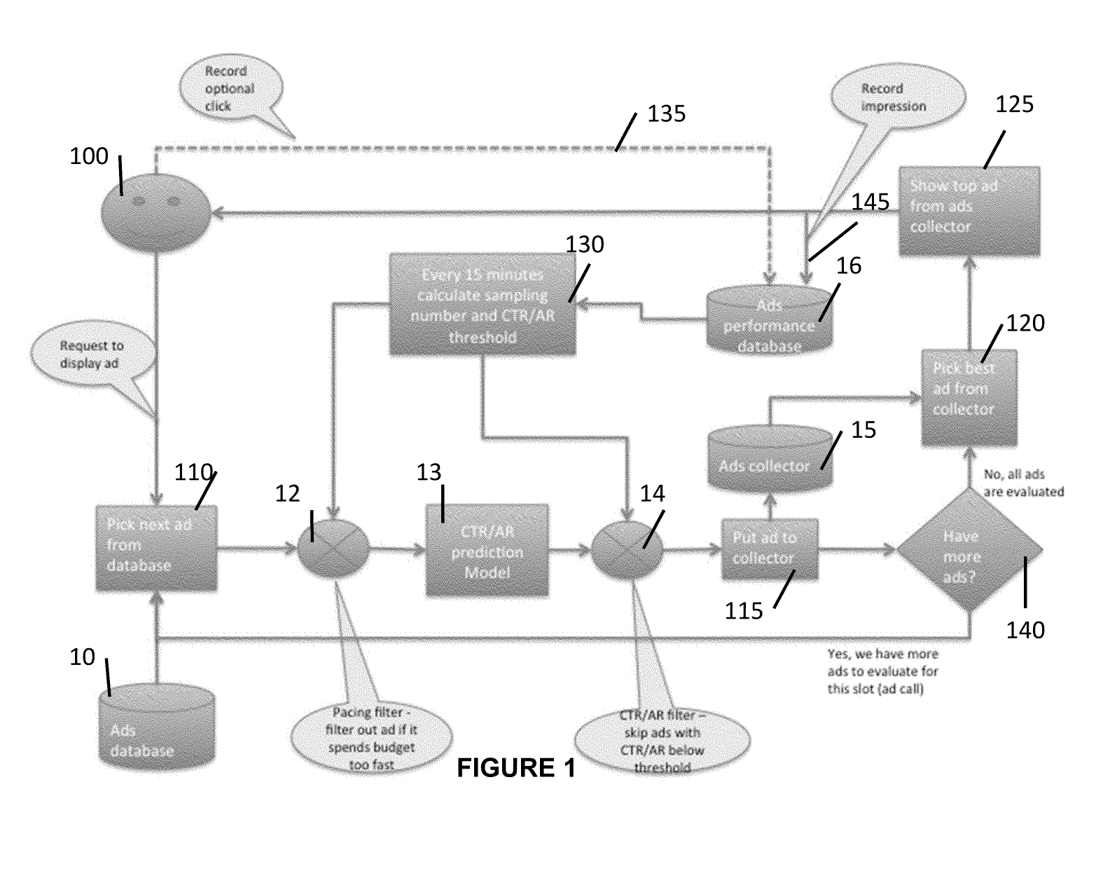

FIG. 1 is a dataflow diagram showing a mechanism for optimizing the delivery of display advertising impressions according to the invention. In FIG. 1, a request (100) to display an ad is sent to the system. The request is typically originated by a code snippet on a Web page, but it also can originate from an inventory aggregator, such as a real time bidding ad exchange. Requests keep coming randomly and in large numbers.

For the incoming request, system iterates through all qualifying ads in an ad database 10 to find the best ad. During each iteration, an ad is first checked against a pacing filter 12 which blocks ads that spend the ad budget too fast. Next, a CTR/AR prediction model 13 assigns a probability of click or action to the ad given an incoming request. This prediction is then passed to a CTR/AR filter 14 which checks it against an ad-specific threshold. If predicted value is high enough, the ad is placed (115) into an intermediate collector 15, and system proceeds to the next ad (110).

Once all of the ads have been evaluated (140), the system picks (120) the best single ad from the collector to sends it back to the Web page (125). The logic of picking the best ad depends on the pricing model. In the simplest scenario, the best ad could be the ad with the highest price advertiser agreed to pay per impression.

The ad sent back to the request originator becomes an ad impression which is recorded (145) into the performance database 16. Data in the performance database is used to calibrate the pacing and CTR/AR filters (130). If user happens to click on the ad or performs a desired action, this is also be recorded (135) into the performance database, and calibrates CTR/AR prediction model.

In some embodiments, the pacing filter and CTR/AR filter can be used independently of each other, although in the presently preferred embodiment they are interdependent. The CTR/AR filter operates on the value of the pacing filter as a driving factor. Depending on the pacing filter value, the CTR/AR filter adjusts the slot fulfillment rate up or down. That is, in an embodiment the CTR/AR filter value depends on the output of the pacing filter.

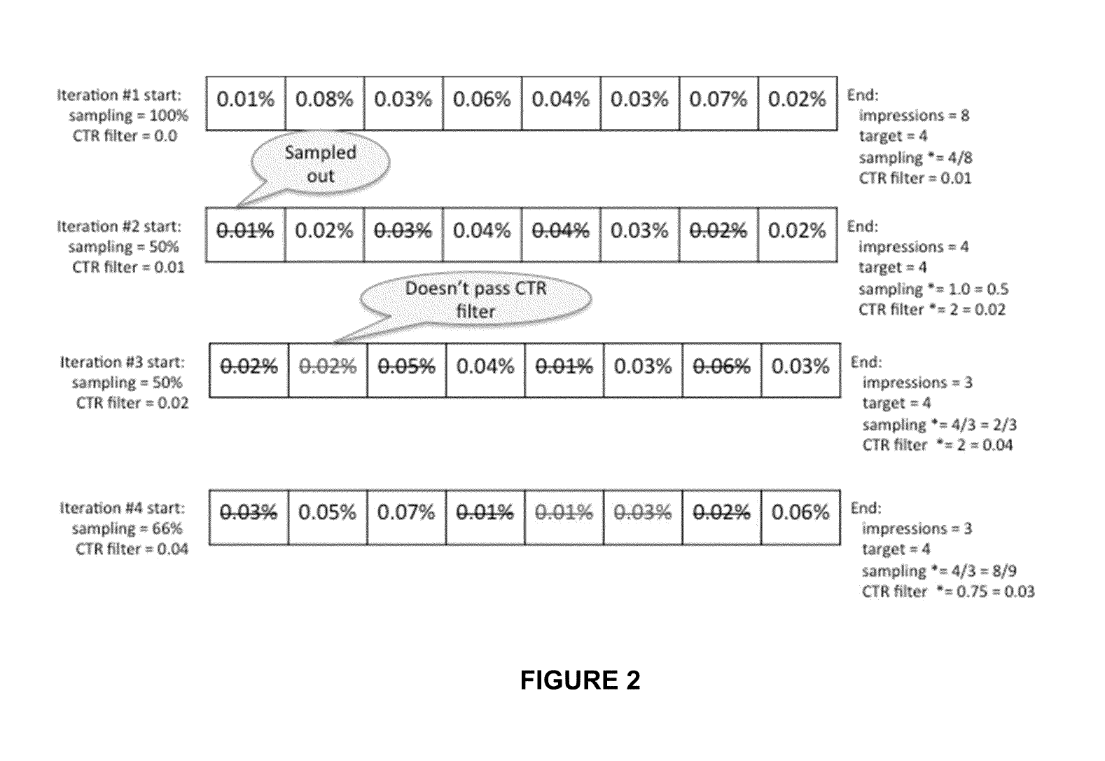

The manner in which the invention selects slots into which impressions are to be placed is best understood with reference to FIG. 2, which shows four iterations of a sampling (pacing filter) and CTR filtering procedure according to the invention. In view of the examples provided in FIG. 2, it should be appreciated that embodiments of the invention comprise two steps.

In operation, one step looks at available slots for placing impressions and, based on the budget of impressions in the available slots, performs a random sampling to determine how to spread those impressions into the available slots. For example, if there are 1,000,000 openings for impressions and the impression budget 100,000, then the advertiser does not want to accept the first 100,000 impressions and then leave the 900,000 impressions that are to occur later in the advertising cycle, but rather wants to spread the impressions throughout the advertising budgeted period of time, e.g. 24 hours.

In the example of FIG. 2, during a first iteration 20 sampling is set to 100% (all slots are selected) and the CTR filter is set to 0.0 (no adjustment is made). In this case, eight slots for impressions are presented. At the end of this sequence, the sampling ratio for the next sequence is determined as a ratio of the target number of impressions we need to serve to spread delivery evenly and the actual number of impressions delivered, here 4 (target)/8 (actual delivery), and the CTR filter is set to 0.01, e.g. minimum acceptable click-through-rate is 1 click over 100 impressions.

There is a time component to this determination. If there are 1,000,000 slots in a day, but the advertiser only has 100,000 impressions, the advertiser may spread the impressions out so that every tenth slot is fulfilled. However, between those ten slots from which an advertiser selects, it is also possible to determine which slot is highest value slot, i.e. the slot having the highest probability of resulting in a click.

A second step considers, once it is known how to spread out the delivery of impressions, how filtering is to be performed based on an estimate of the click-rate per impression for each of the impressions, which is estimated by the CTR prediction model. In FIG. 2, the probability of a click for each slot is shown in the slot. Accordingly, not only do embodiments of the invention spread the delivery of impressions out, but they also attempt to predict the best point to place the impression to give the best return in terms of the click rate. Thus, the invention both selects a nearly correct portion of the slots necessary to fill the impression budget and chooses the highest value slots as part of the selection as well.

Because only one impression is presented at a time, embodiments look at the last period of time and estimate the rate of impressions in common versus a target number of impressions that are needed. This aspect of the invention includes a feedback loop to adjust the rate of impressions on a fixed interval in fixed steps which comprise, for example, linear increments, exponential increments, etc.

As discussed above, embodiments can cherry-pick impression bids having a highest CTR. For some bids, it is possible to predict a click-through rate using a dynamic filter (pacing filter) that is calibrated, for example, every 15 minutes. This serves to increase or decrease the budget spend to meet the goal of budget fulfillment, or keep the budget spend the same if spend rate is about right. If the budget is large and it may not possible to fulfill it, then there is not any cherry-picking. That is, the filter is automatically turned off so it has no negative side effect, i.e. to keep it from damping the slot selection process.

The filter comprises an algorithm that is implemented over a series of iterations. For example, FIG. 2 shows four iterations 20, 22, 24, 26. It is not practical to readjust the filter for each and every impression, so the algorithm looks at the aggregate, where each iteration in one embodiment is typically 15 minutes. Thus, for a first iteration in FIG. 2, every 15 minutes the sampling is 100 percent, which means every slot is accepted and CTR filter is zero. For each impression there is a corresponding predicted click rate. At the end of a cycle, the number of impressions served is examined, e.g. eight impressions were served. In this example, the actual target is based on a budget of four impressions. The filter then adjusts the sampling to 50 percent, so that it is only necessary to accept half of the impressions during the next iteration because 100 percent are not needed to make the budget at the current rate.

The click-through rate filter is initialized with a seed value, which can be any desired non-zero constant. Picking too high value might hurt delivery in the first few iterations because predicted CTR is lower than seed threshold. Picking too small value prolongs searching for ideal threshold, and allows too many impressions with poor CTR. One way to pick seed value is take average expected CTR and divide it by 10.

On the second iteration 22 shown in FIG. 2, every other impression is filtered out. The strikethrough in FIG. 2 indicates that the slot is sampled out of the sample iteration. In this example, the sample is 50 percent, so every other slot is removed. At the end of the cycle, the number of impressions is four and the target is four as well, so sampling is not changed, it is still 50 percent. However, the CTR filter can be increased because the sample number is only 50 percent. That means there is an extra capacity. In this case, the CTR filter is increased to perform extra filtering. The actual function to increase CTR filter value is to multiply it on some constant. The constant picked for this example is 2, so the next value for the filter is 0.02. Finding the right increase constant depends on the environment and requires tuning. High value indicates more aggressive filtering and a better average CTR, but with risks of hurting delivery.

Thus, during the third iteration 24, the sampling is 50 percent and the CTR filter is 0.02. The sampling (pacing filter) and CTR filtering steps are both implemented. In this example, one of the slots that passes the sampling has a click probability of 0.02, which is too low for the CTR filter, and this slot is thus skipped. As a result, the only slots that are left are those with a relatively high click-through rate. e.g. 0.04, 0.03, 0.03. Less impressions are served than are in in the target, i.e. three impression vs. a target of four, but those slots that are selected are the highest value slots.

For the fourth iteration 26, the sampling is modified accordingly from 50 percent, to a ratio of ⅔, i.e. about 66 percent. This allows more slots, but the value of the CTR filter is also increased to 0.04. As a result, a balance is achieved where more slots are passed to the CTR filter by the pacing and fewer, but higher value, slots are passed through by the CTR filter. At the end of the fourth iteration, the impression vs. target are again considered and the sample ratio and CTR filter are adjusted appropriately. This process repeats for each interval until the impression budget is exhausted. If the budget is expended at a less than desired rate, the CTR filter may be decreased to allow the budget spend to increase and/or the pacing filter may be increased; likewise, if the budget is being expended too quickly, the CTR filter may be increased and the pacing filter may be decreased. Where the budget is spent too quickly, it may be desirable to increase the CTR filter threshold first and thereby select higher value impressions and, if this is not sufficient, the pacing filter can be slowed; likewise, where the budget is being spent too slowly, the pacing filter may first be increased so that the highest value impressions are still being selected and, if this is insufficient, then the CTR filter threshold may be lowered.

Pacing Filter

An example of a pacing filter is as follows:

• Control loop:
Every 15 minutes for each ad:
If samplingNumber is not initialized then

samplingNumber = 0.01

Else

actualDeliveryRate = $ spent since last check
targetDeliveryRate = ($ left)/(time left in the day)

If actualDeliveryRate > 0 then

samplingNumber*=targetDeliveryRate/actualDeliveryRate ¹

Else

samplingNumber = 1.0

Send ad's sampling number to runtime ad servers

Runtime (ad request):

Skip ad if random( )>samplingNumber

function random( ) returns random floating point number between 0.0 and
1.0
¹ A *= B is equivalent to A = A*B

CTR Filter

An example of a CTR filter is as follows:

• Control loop
Every 15 minutes for each ad:
If samplingNumber < “floor value”⁽¹⁾ then

If CTR threshold is not initialized then

CTR⁽²⁾ threshold = “initial value”

Else

CTR threshold *= “increase factor”

Else if samplingNumber > “ceiling value” tnen

If CTR threshold is not initialized then

CTR threshold = 0

Else

CTR threshold *= “decrease factor”

Else

```
If CTR threshold is not initialized then
  CTR threshold = “initial value”
Else
  Do not change current CTR threshold
```

Runtime (ad request)

Skip ad if predicted CTR < threshold
Notes:
⁽¹⁾Algorithm parameters are in cursive, as defined below.
⁽²⁾CTR—click through rate. Ratio of clicks to impressions.
3) Same logic is applicable if the target is maximizing the actions rate (AR). We just need to replace CTR with AR

CTR Filter Parameters

Example CTR filter parameters are as follows:
Various algorithm parameters in use should be tuned for specific market conditions, e.g. text ads might behave differently than display ads
Current parameter values used:
“initial value”=0.01%
Higher values would make filtering more aggressive, but might also make traffic more volatile
“increase factor”=1.5
“decrease factor”=0.5
Increase and decrease factors work together, and need to be different to avoid oscillation between two threshold values
“floor value”=0.5
“ceiling value”=0.9
Floor and ceiling define two values for sampling number (derived by “pacing filter”). The range is from 0.0 to 1.0. Low sampling number indicates excess of incoming ad requests, and ability to cherry pick. High values indicate we need to accept all ad requests we can get to satisfy the budget.
The range between floor and ceiling is the neutral zone. A wider neutral zone makes algorithm more stable, but also restricts search for maximum performance.

CTR/AR Prediction Model

An example of a CTR model is as follows:
The interface is defined by the function:

Ad CTR/AR=F(ad features, user features, context features),
where:
   Ad features—any characteristics of the ad, such as content, industry, e.g. “insurance” or “mobile,” size, etc.
   User features—any characteristic of the user browsing the page, such as geo location, browsing/shopping history, type of OS/Browser software, local day of week, time, etc.
   Context features—anything about page from where ad request is originated, such as domain name, site category, page category, text on the page, search keywords leading to the page, etc.

Presently preferred embodiments typically use a combination of these two methodologies:
Machine learning—train function using examples of (not) clicks, using algorithms, such as decision trees, logistic regression, neural networks, etc.
Hierarchal statistical model—rely on numerous past performance aggregates, such as historical performance of ad on this domain, this category of sites, this segment of users, etc.

Computer Implementation

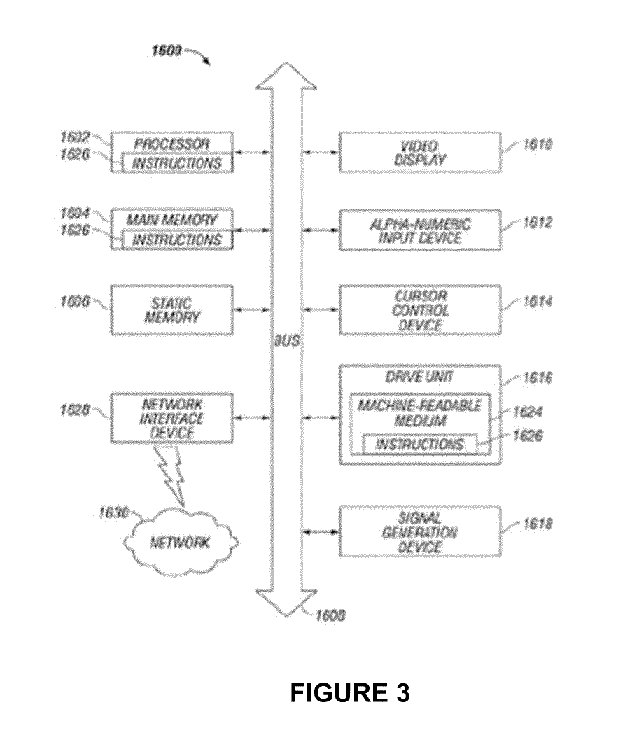

FIG. 3 is a block schematic diagram of a machine in the exemplary form of a computer system 1600 within which a set of instructions for causing the machine to perform any one of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for optimizing delivery of display advertising impressions, comprising:
providing a processor configured, within a fixed advertising budget to be spent within certain time period, for subtracting a predetermined amount from said budget for each impression delivered, said processor implementing and applying a pacing filter that iteratively, and as a priority, spends said budget entirely; and
said processor configured for implementing and applying a click rate per impression (CTR) filter which establishes a CTR probability threshold that iteratively, and subordinately to said pacing filter, maximizes said CTR among the fixed number of impressions delivered.

2. The method of claim 1, further comprising:
said processor configured for implementing and applying an action per impression rate (AR) filter which establishes an AR probability threshold that iteratively, and subordinately to said pacing filter, maximizes said AR among a fixed number of impressions delivered.

3. The method of claim 1, said certain time period comprising one day.

4. The method of claim 1, said certain amount subtracted from said budget comprises any of a fixed or a variable amount.

5. The method of claim 1, wherein said CTR probability is estimated separately for each impression to which said CTR filter is applied.

6. The method of claim 1, wherein said CTR filter tests every impression delivered by said pacing filter against said threshold to determine whether to accept the impression or not.

7. The method of claim 1, wherein said pacing filter comprises a controlled feedback mechanism that re-estimates said budgeted at each iteration over fixed time periods to determine if said budget spending rate is on target;
wherein if too much of said budget is spent, said pacing filter threshold is raised; and
wherein if an insufficient amount of said budget is spent, said pacing filter threshold is lowered.

8. An apparatus for optimizing the delivery of display advertising impressions, comprising:
a processor configured for making an ad request to a database to request display of an ad;
wherein a sequence of ad slots is available over a time interval;
said processor executing a pacing filter to apply a sampling rate to said sequence of slots to select slots, wherein said pacing filters refrains from placing a predetermined number of ads within said sequence of slots if placing an impression within the slot results in spending an ad budget too quickly and wherein said pacing filter places a predetermined number of ads within said sequence of slots if not placing an impression within the slot results in spending an ad budget too slowly;
said processor executing a click-through rate (CTR) prediction model to assign a CTR prediction value to each ad slot;
said processor configured for iteratively calculating a sampling rate for use by said pacing filter and a CTR threshold value for use by a processor implemented CTR filter; and
said processor configured for passing said CTR prediction value and said selected slots through said CTR filter to skip ad slots that have a CTR prediction value that is below said CTR threshold value.

9. The apparatus of claim 8, further comprising:
said processor configured for implementing and applying an action per impression rate (AR) filter which establishes an AR probability threshold that iteratively, and subordinately to said pacing filter, maximizes said AR among a fixed number of impressions delivered.

10. The apparatus of claim 8, said processor configured for selecting a top ad and placing said ad in a slot for display to a user.

11. The apparatus of claim 8, said processor configured for providing feedback when delivery of an impression is recorded in an ad performance database.

12. The apparatus of claim 11, said processor configured for providing feedback when a click in response to an impression is recorded in an ad performance database.

13. The apparatus of claim 11, wherein said ad performance database provides adjusted pacing filter and CTR filter values for a next iteration.

14. The apparatus of claim 8, said processor configured for, at each iteration, comparing said ad budget to said pacing filter sampling rate and CTR threshold and for adjusting any of said pacing filter sampling rate and CTR threshold to, in order of priority, fill said ad budget and place impressions in slots having a highest CTR prediction value.

15. The apparatus of claim 8, wherein said pacing filter and CTR filter operate independently of each other.

16. A method for optimizing the delivery of display advertising impressions, comprising:
providing a processor configured for examining available advertising impression slots and, based on an ad budget, performing a random sampling to spread placement of ad impressions over available slots; and
said processor configured for, after spreading placement of said ad impressions over said available slots, placing ad impressions in slots selected from among said spread ad impressions based upon an estimate of a click-rate per impression for each of said impressions;
said processor configured for providing a feedback loop to adjust a rate of impressions on a fixed interval in fixed steps based upon said random sampling and said estimate of a click-rate per impression.

17. The method of claim 16, further comprising:
said processor configured for implementing and applying an action per impression rate (AR) filter which establishes an AR probability threshold that iteratively, and subordinately to said pacing filter, maximizes said AR among a fixed number of impressions delivered.

18. A method for optimizing delivery of display advertising impressions, comprising:
providing a processor configured, within a fixed advertising budget to be spent within certain time period, for subtracting a predetermined amount from said budget for each impression delivered, said processor implementing and applying a pacing filter that iteratively, and as a priority, spends said budget entirely; and
said processor configured for implementing and applying an action per impression rate (AR) filter which establishes an AR probability threshold that iteratively, and subordinately to said pacing filter, maximizes said AR among a fixed number of impressions delivered.

19. An apparatus for optimizing the delivery of display advertising impressions, comprising:
a processor configured for making an ad request to a database to request display of an ad;
wherein a sequence of ad slots is available over a time interval;
said processor executing a pacing filter to apply a sampling rate to said sequence of slots to select slots, wherein said pacing filters refrains from placing a predetermined number of ads within said sequence of slots if placing an impression within the slot results in spending an ad budget too quickly and wherein said pacing filter places a predetermined number of ads within said sequence of slots if not placing an impression within the slot results in spending an ad budget too slowly;
said processor executing an action per impression rate (AR) filter to assign an AR prediction value to each ad slot;
said processor configured for iteratively calculating a sampling rate for use by said pacing filter and an AR threshold value for use by a processor implemented AR filter; and
said processor configured for passing said AR prediction value and said selected slots through said AR filter to skip ad slots that have a AR prediction value that is below said AR threshold value.

20. The apparatus of claim 19, said processor configured for selecting a top ad and placing said ad in a slot for display to a user.

21. The apparatus of claim 19, said processor configured for providing feedback when delivery of an impression is recorded in an ad performance database.

22. The apparatus of claim 21, said processor configured for providing feedback when a click in response to an impression is recorded in an ad performance database.

23. The apparatus of claim 21, wherein said ad performance database provides adjusted pacing filter and AR filter values for a next iteration.

24. The apparatus of claim 19, said processor configured for, at each iteration, comparing said ad budget to said pacing filter sampling rate and AR threshold and for adjusting any of said pacing filter sampling rate and AR threshold to, in order of priority, fill said ad budget and place impressions in slots having a highest AR prediction value.

25. The apparatus of claim 19, wherein said pacing filter and AR filter operate independently of each other.
